(19) United States
(12) Patent Application Publication
(10) Pub. No.: US 2011/0044488 A1
(43) Pub. Date: Feb. 24, 2011

(54) PRENATAL AUDIO SYSTEM

(76) Inventor: Christopher Laubis, Lincolndale, NY (US)

Correspondence Address: ITALIA IP, 3500 WEST OLIVE AVE., SUITE 300, BURBANK, CA, 91505, US

(21) Appl. No.: 12/543,323

(22) Filed: Aug. 18, 2009

(51) Int. Cl. H04R 1/02

(52) U.S. Cl. 381/386

(57) ABSTRACT

A system for transmitting sounds to an in utero being. The system includes a first speaker capable of transmitting sound to an in utero being and a first bendable member coupled to the first speaker. The first bendable member is flexible enough to allow the first bendable member to be bent to a desired position and rigid enough to hold the first bendable section in the desired position. A clip is coupled to the first bendable member, the clip operable to releasably secure the first bendable member to a user.

### BACKGROUND OF THE INVENTION

This application relates to transmitting sound to in utero babies and more particularly to portable systems for transmitting sound to in utero babies.

### SUMMARY

Medical science is now starting to show that hearing and brain development of babies in utero may be enhanced by introduction of sounds, and in particular, but not solely, music. However, given the busy lifestyle of many moms-to-be, providing such acoustic stimulation to in utero babies can be challenging. Additionally, given the relatively quick growth of babies in utero and related expansion of the mother, it is difficult to accommodate such grow comfortably with a portable and/or localized system. Therefore, there exists a significant need for a portable prenatal audio system.

In particular, this application discloses A system for transmitting sounds to an in utero being, the system comprising: a first speaker capable of transmitting sound to an in utero being; a first bendable member coupled to the first speaker, the first bendable member being flexible enough to allow the first bendable member to be bent to a desired position and the first bendable member also being rigid enough to hold the first bendable section in the desired position; and a clip coupled to the first bendable member, the clip operable to releasably secure the first bendable member to a user.

This application also discloses a system for transmitting sounds to an in utero being, the system comprising: a first speaker capable of transmitting sound to an in utero being; a second speaker capable of transmitting sound to an in utero being;a first bendable member coupled to the first speaker, the first bendable member being flexible enough to allow the first bendable member to be bent to a desired position and the first bendable member also being rigid enough to hold the first bendable section in the desired position; a second bendable member coupled to the second speaker, the second bendable member being flexible enough to allow the second bendable member to be bent to a desired position and the second bendable member also being rigid enough to hold the second bendable section in the desired position; and a clip coupled to at least one of the first and second bendable members, the clip operable to releasably secure at least one of the first and second bendable members to a user.

### BRIEF DESCRIPTION OF THE DRAWINGS

The drawings, when considered in connection with the following description, are presented for the purpose of facilitating an understanding of the subject matter sought to be protected.

FIG. 1 is an environmental view of a prenatal audio system; and

FIG. 2 is a perspective view of the prenatal audio system of FIG. 1.

### DETAILED DESCRIPTION

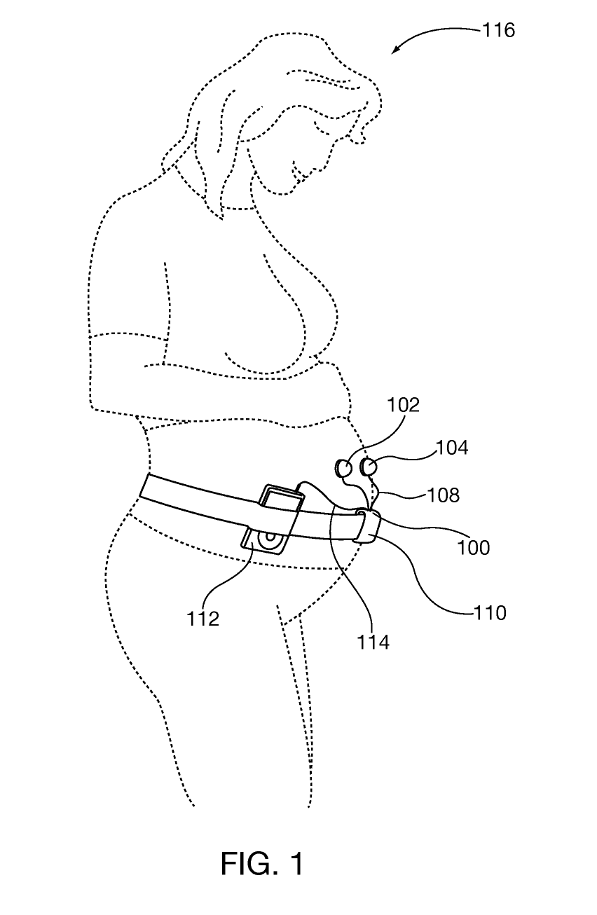

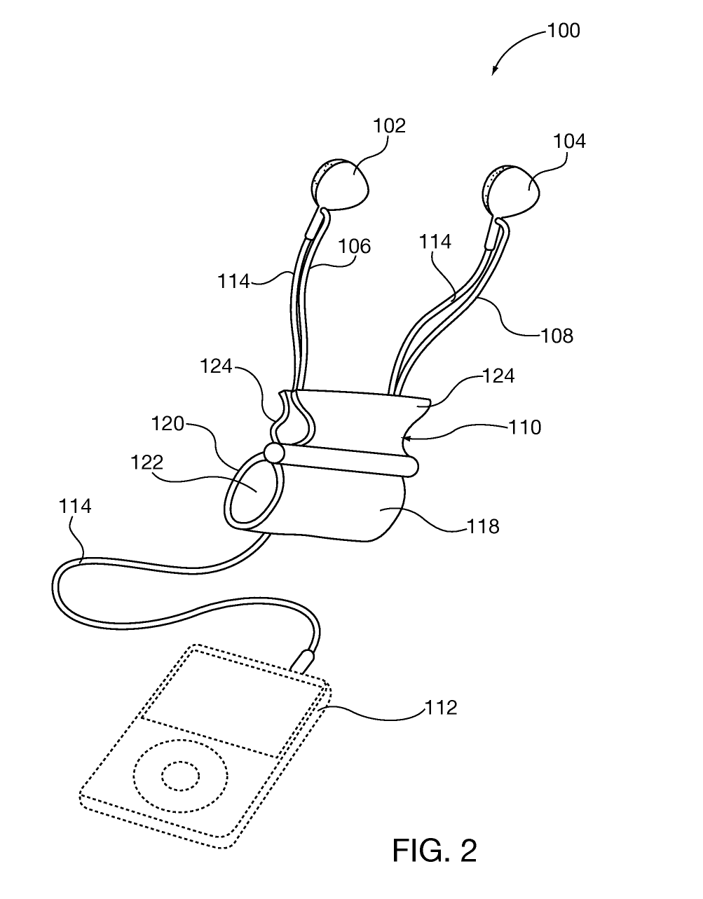

Referring now to FIGS. 1-2 wherein like numerals indicate like elements throughout and wherein a system 100 for transmitting sounds to an in utero being is shown. The system 100 generally comprises a first speaker 102, a second speaker 104, a first bendable member 106, a second bendable member 108, and a clip 110. The speakers 102, 104 may each be any suitable speaker suitable for transmitting sound to an in utero being. For example, and without limitation, each speaker 102, 104 may be an “ear-bud” speaker. However, it will be appreciated that any suitable speaker may be employed and remain within the scope of the present disclosure. Additionally, while the illustrative embodiment shows a two speakers 102, 104, it will be appreciated that any suitable number of speakers may be employed and remain within the scope of the present disclosure.

Each speaker 102, 104 may be configured to transmit sound generated from at least one audio device 112. The audio device 112 may be any device capable of generating sound, including, but not limited to a mp3 player, a CD player, audio-cassette player, noise generator, smart phone, radio, etc. The audio device 112 may be configured to play music, spoken word tracks, noise (e.g., pink noise, white noise, etc.), or any other suitable sound or noise. Additionally, the audio device 112 may be configured to generate monaural, binaural, stereo, etc. sound or noise. The speakers 102, 104 and audio device(s) 112 may communicate via any suitable means. In the illustrative embodiment, at least one bifurcated cable 114 provides electrical communication between each speaker 102, 104 and the audio device 112. However, it will be appreciated that the speakers 102, 104 and audio device 112 may communicate via any suitable means, including, but not limited to, wired communication, wireless communication, etc.

Each speaker 102, 104 is coupled to a corresponding bendable member 106, 108 (e.g., the first speaker 102 is coupled to a first bendable member 106 and the second speaker 104 is coupled to a second bendable member 108). Each speaker 102, 104 may be coupled to the corresponding bendable member 106, 108 via any suitable means, including, but not limited to, mechanical fasteners, bonding, adhesive, welding (e.g., spot weld, sonic weld, etc.), etc. Each bendable member 106, 108 is configured to be flexible enough to allow the bendable member 106, 108 to be bent to a desired position while also being rigid enough to hold the bendable member 106, 108 in the desired position. Thus, each bendable member 106, 108 is operable to allow the speakers 102, 104 to be adjusted between users, as well as be adjusted to accommodate the user's expansion as a baby grows in utero. While the present disclosure illustrates the system 100 in context of human beings, it will be appreciated that the system 100 may be employed with any suitable creature. Each bendable member 106, 108 may be formed from any suitable material, including, but not limited to, metal, polymer, composite, etc. Each bendable member 106, 108 is coupled to the clip 110. The bendable members 106, 108 may be coupled to the clip 110 via any suitable means, including, but not limited to, mechanical fasteners, bonding, adhesive, welding (e.g., spot weld, sonic weld, etc.), etc. While two bendable members 106, 108 are shown, it will be appreciated that any suitable number of bendable members may be employed and remain within the scope of the present disclosure. For example, and without limitation, two or more speakers may be coupled to the same bendable member. Moreover, and by way of another non-limiting example, a plurality of speakers may be employed with each speaker being coupled to a corresponding bendable member.

The clip 110 is operable to releasably secure each bendable member 106, 108 to a user 116. The clip 110 may have any suitable configuration capable of releasably securing the bendable members 106, 108 to a user 116. In the illustrative embodiment, the clip 110 is an “alligator” style clip having a first jaw portion 118 and a second jaw portion 120 defining a mouth 122 for receiving a portion of the user's attire therein. The clip 110 may be biased to a closed position by a torsion spring (not shown). The first and second jaw portions 118, 120 may be separated by depressing one or more upper finger pads 124 whereafter a portion of the user's attire may be disposed within the mouth portion 122. The finger pad(s) 124 may then be released to secure the bendable members 106, 108 to the user's attire. While the illustrative embodiment employs an “alligator” style clip, it will be appreciated that any device suitable for releasably securing each bendable member 106, 108 to a user may be employed and the present disclosure is not limited solely to such an “alligator” style clip. The clip 110 may be secured to the user at any suitable location, including, but not limited to, a belt, a waistline of a shirt or pants, a bra, or any other suitable location.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A system for transmitting sounds to an in utero being, the system comprising:
a first speaker capable of transmitting sound to an in utero being;
a first bendable member coupled to the first speaker, the first bendable member being flexible enough to allow the first bendable member to be bent to a desired position and the first bendable member also being rigid enough to hold the first bendable section in the desired position; and
a clip coupled to the first bendable member, the clip operable to releasably secure the first bendable member to a user.

2. The system of claim 1 further comprising a second speaker.

3. The system of claim 2 wherein said second speaker is capable of transmitting sounds to an in utero being.

4. The system of claim 3 further comprising a second bendable member coupled to the second speaker, the second bendable member being flexible enough to allow the second bendable member to be bent to a desired position and the second bendable member also being rigid enough to hold the second bendable section in the desired position, wherein the second bendable member is coupled to the clip.

5. The system of claim 1 further comprising a cable in electrical communication with the first speaker, the cable operable to provide electrical communication between the first speaker and an audio device.

6. The system of claim 1 further comprising an audio device in communication with the first speaker, the audio device operable to generate sound for the first speaker to transmit.

7. A system for transmitting sounds to an in utero being, the system comprising:
a first speaker capable of transmitting sound to an in utero being;
a second speaker capable of transmitting sound to an in utero being;
a first bendable member coupled to the first speaker, the first bendable member being flexible enough to allow the first bendable member to be bent to a desired position and the first bendable member also being rigid enough to hold the first bendable section in the desired position;
a second bendable member coupled to the second speaker, the second bendable member being flexible enough to allow the second bendable member to be bent to a desired position and the second bendable member also being rigid enough to hold the second bendable section in the desired position; and
a clip coupled to at least one of the first and second bendable members, the clip operable to releasably secure at least one of the first and second bendable members to a user.

8. The system of claim 7 further comprising a cable in electrical communication with the first and second speakers, the cable operable to provide electrical communication between the first and second speakers and an audio device.

9. The system of claim 7 further comprising an audio device in communication with the first and second speakers, the audio device operable to generate sound for the first and second speakers to transmit.

10. The system of claim 7 further comprising a second clip coupled to the other of the first and second bendable members, the second clip operable to releasably secure the other of the first and second bendable members to the user.
